(19) United States
(12) Patent Application Publication
(10) Pub. No.: US 2007/0208158 A1
(43) Pub. Date: Sep. 6, 2007

(54) Polyurethane Containing Carbodiimides

(75) Inventor: Markus Kramer, Stemshorn (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/547,278

(22) PCT Filed: May 4, 2005
(86) PCT No.: PCT/EP05/04818

§ 371 Date: Oct. 4, 2006

(30) Foreign Application Priority Data
May 13, 2004 (DE) 102004024205.4

(51) Int. Cl. C08G 18/81

(52) U.S. Cl. 528/45

(57) ABSTRACT

Polyurethanes comprising carbodiimide which has at least one alkenyl unit, and has a content smaller than 5 ppm, based on the total weight of the carbodiimide, of compounds which catalyze the formation of carbodiimides.

The invention relates to polyurethanes, preferably thermoplastic polyurethanes, comprising carbodiimide which has at least one, preferably two, alkenyl unit(s), preferably at least one, particularly preferably two, isopropenyl unit(s), and has a content smaller than 5 ppm, based on the total weight of the carbodiimide, of compounds which catalyze the formation of carbodiimides, preferably phospholenes, phospholene oxides, phospholidines, and/or phospholine oxides, particularly preferably 1-methyl-2-phospholene 1-oxide.

The invention further relates to a process for the preparation of polyurethanes, preferably of thermoplastic polyurethanes, preferably via reaction of isocyanates, compounds reactive toward isocyanates, if appropriate blowing agents, and if appropriate catalysts, and auxiliaries and/or additives, which comprises carrying out the reaction in the presence of the inventive carbodiimides.

Organic carbodiimides are known and are used by way of example as stabilizer to inhibit hydrolytic degradation of compounds containing ester groups, for example of polyaddition and polycondensation products, e.g. polyurethanes. Carbodiimides can be prepared by well-known processes, e.g. via action of basic catalysts on mono- or polyisocyanates with elimination of carbon dioxide. Examples of suitable catalysts are heterocyclic phosphorus-containing compounds, metal carbonyls, phospholines, phospholenes, and phospholidines, and also their oxides and sulfides.

By way of example, DE-A 4 318 979, DE-A 4 442 724, and EP-A 460 481 describe these carbodiimides, their preparation, and their use as stabilizers to inhibit hydrolytic cleavage of polyester-based plastics.

The prior art also discloses carbodiimides having unsaturated units. U.S. Pat. No. 5,105,010, EP-A 638 066, JP 09-136869 and JP 09-124582 describe the preparation of carbodiimides which have aryl units, for example.

The object of the present invention was to develop improved carbodiimides which are stabilizers to inhibit hydrolytic cleavage of polyester-based plastics, which have ideal ease of incorporation into the starting components of the plastics or into the plastics themselves, and which moreover do not adversely affect the dynamic and static properties of the plastics, in particular of polyurethane elastomers. A particular objective was to retain the property profile of the plastics to be stabilized, in particular of the thermoplastic polyurethane, even under conditions in which hydrolysis usually occurs.

This object has been achieved by the carbodiimides described at the outset.

In purely statistical terms, the hydrolytic degradation of a polyester cleaves one molecule to give two molecules. This is associated with a corresponding fall in molar mass. When the carbodiimide is used, the acid-containing polymer radical is intercepted, the result being combination of these two molecules. However, this does not solve the problem of molecular weight degradation. The particular advantage of the inventive carbodiimides is firstly their excellent efficacy as hydrolysis stabilizers and secondly their ability, by way of the alkenyl, preferably isopropenyl, units at the end of the carbodiimide, to generate crosslinking and thus increase the molar masses within the polymer. This particular advantage is especially useful in thermoplastics, being particularly advantageous in thermoplastic polyurethane.

Using the inventive carbodiimides, and by way of the unsaturated units of the carbodiimide, the polymerization process, which can be accelerated by well-known catalysts or initiators, provides particularly effective crosslinking capacity which can bring about a marked increase in molecular weight in the polymer, thus giving the polymer very good properties.

The crosslinking by way of the unsaturated units, in particular the isopropenyl units, may be achieved via free-radical combination of the propenyl group with free-radical constituents in the TPU, these arising, for example, via steps in the process or ageing via the effect of, for example, oxygen.

Other advantages of the inventive carbodiimides are the following:
easy to prepare
can be incorporated into TPU without side-reactions
low viscosities at processing temperature (60° C.)
pumpable at room temperature
stable in storage
effective as hydrolysis stabilizers, in particular when catalyst is absent, i.e. with markedly reduced content of, by way of example, phospholene oxide
low volatility
low cost
reaction in bulk, i.e. without solvent

The low content of catalysts which can be used for the formation of the carbodiimides makes the present carbodiimides suitable for the stabilization of polyurethanes, in particular of thermoplastic polyurethanes, in contrast to the well-known carbodiimides treated as prior art at the outset. The basis of this particularly good action is that the catalysts for the preparation of the carbodiimides catalyze the hydrolysis of ester groups and therefore undesirably accelerate degradation.

The following carbodiimide is preferred and can be termed bis[1-(3-isopropenylphenyl)-1-methylethyl]carbodiimide:

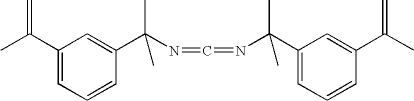

The following carbodiimides are particularly preferred: 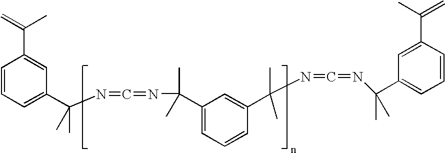
with the following meaning for n: 1, 2, 3, 4, 5, 6, 7, 8, 9, 10, 11, 12, 13, 14, 15, 16, 17, 18, 19 or 20, preferably from 2 to 15, particularly preferably from 3 to 10.

The inventive carbodiimides are prepared via well-known reaction of the isocyanate groups with one another, with elimination of carbon dioxide, in the presence of conventional catalysts known for this reaction and described at the outset.

By way of example, in one method of obtaining the inventive carbodiimides 1-(3-isopropenylphenyl)-1-methylethyl isocyanate is reacted alone or together with other isocyanates, in particular 1,3-bis(1-methyl-1-isocyanatoethyl)benzene, in the presence of catalysts, with elimination of carbon dioxide, to give carbodiimides. A possible alternative begins by reacting a diisocyanate, in particular 1,3-bis(1-methyl-1-isocyanatoethyl)benzene, to give the corresponding carbodiimide, and then reacting the free isocyanate groups with 1-(3-isopropenylphenyl)-1-methylethyl isocyanate to give the carbodiimide. If 1-(3-isopropenylphenyl)-1-methylethyl isocyanate is reacted alone without other isocyanates to give the carbodiimide, the product is bis[1-(3-isopropenylphenyl)-1-methylethyl]carbodiimide.

The inventive carbodiimides may be stabilized via well-known stabilizers, e.g. phenolic antioxidants or HALS compounds, in order to avoid spontaneous oligomerization/polymerization of the double bonds. This type of stabilization is known for stabilizing styrene, for example.

The product, i.e. the inventive carbodiimide, preferably has an NCO content smaller than 1% by weight, particularly preferably from 0.5 to 0.01% by weight.

The preparation of the inventive carbodiimides via reaction of diisocyanates may be condensed at elevated temperatures, e.g. at temperatures of from 50 to 200° C., preferably from 150 to 185° C., advantageously in the presence of catalysts, with elimination of carbon dioxide. GB-A-1 083 410, DE-B 1 130 594 (GB-A-851 936), and DE-A-11 56 401 (U.S. Pat. No. 3,502,722) describe, by way of example, processes suitable for this purpose. Catalysts which have proven preferably suitable are, by way of example, phosphorus compounds, preferably selected from the group of the phospholenes, phospholene oxides, phospholidines, and phospholine oxides. Formation of the polycarbodiimide is usually terminated when the reaction mixture has the desired content of NCO groups. To this end, the catalysts may be distilled off at reduced pressure or deactivated via addition of a deactivator, e.g. phosphorus trichloride. According to the invention, the catalyst mentioned at the outset is removed from the carbodiimide. The polycarbodiimides may moreover be prepared in the absence or presence of solvents inert under the reaction conditions.

The person skilled in the art can adjust the degree of condensation in the usual way via suitable choice of the reaction conditions, e.g. the reaction temperature, the type of catalyst, and the amount of catalyst, and also the reaction time. The simplest method of monitoring the reaction is determination of NCO content. Other parameters such as viscosity rise, deepening of color, or CO₂ evolution, can be utilized in order to monitor and control the reaction. The method of measurement may be HPLC or GPC/SEC, for example.

The isocyanate used to prepare the inventive carbodiimides may be well-known isocyanates, preferably diisocyanates which have unsaturated units. These isocyanates may be used alone or together with other isocyanates, preferably with diisocyanates, such as hexamethylene diisocyanate, 1-isocyanato-3,3,5-trimethyl-5-isocyanatomethylcyclohexane (isophorone diisocyanate), di(cyclohexyl)methane diisocyanate, trimethylhexamethylene diisocyanate, dodecane diisocyanate, octane diisocyanate, and/or cyclohexane 1,4-diisocyanate. The isocyanates described at the outset are preferably used.

The inventive monocarbodiimides and/or oligomeric polycarbodiimides have excellent suitability as acceptors for carboxy compounds and are therefore used according to the invention as stabilizers to inhibit hydrolytic degradation of polyurethanes, in particular of polyurethanes containing ester groups.

Polyurethanes are well known, as are thermoplastic polyurethanes. The standard literature has many descriptions of their starting materials, preparation processes, structures, and properties. The good solubility of the inventive (poly)carbodiimides in the structural components for the preparation of polyurethanes, and their good compatibility with the polyurethanes formed, make them particularly suitable as stabilizers to inhibit hydrolytic degradation of polyurethanes, preferably of compact or cellular polyurethane elastomers, and in particular of thermoplastic polyurethanes, and also of cellular or compact elastomers.

The concentration of the inventive carbodiimides in the polycondensation or polyaddition products to be stabilized and containing ester groups is generally from 0.05 to 10% by weight, preferably from 0.1 to 5% by weight, based on the total weight of the mixture. The concentration may also be higher in individual instances, depending on the level of hydrolytic stress to which the plastic is exposed.

Various methods can be used to introduce the carbodiimides which may be used according to the invention into the products which are to be stabilized and which contain ester groups. By way of example, the inventive carbodiimides may be mixed with one of the structural components for the preparation of the polyaddition products, e.g. with the polyisocyanates and/or polyhydroxy compounds for the preparation of polyurethanes, or the carbodiimides may be metered into the reaction mixture for the preparation of the polyurethanes. In another procedure, the inventive carbodiimides may be incorporated into the melt of the fully reacted polyaddition or polycondensation products. However, it is also possible for granules of the polyaddition or polycondensation products to be coated with the inventive carbodiimides, or mixed with the pulverized, pelletized, or granulated inventive carbodiimides, and introduced into the plastics compositions during subsequent production of moldings via melt extrusion. In one preferred embodiment for the preparation of pourable polyurethane elastomers and polyester-based TPUs, the polyester polyols containing carboxy groups are first treated with the inventive carbodiimides, to reduce acid content, and these are then reacted with polyisocyanates, if appropriate with addition of further amounts of carbodiimides, and if appropriate in the presence of additional auxiliaries and additives. The inventive carbodiimides may also be introduced into the polyurethane by way of the isocyanate component. However, the inventive carbodiimides are particularly useful when they are introduced into the polymer containing ester groups during conventional manufacturing processes.

The inventive carbodiimides are particularly preferably used during the preparation of polyurethanes, e.g. of cellular, for example microcellular, polyurethanes, preferably of polyurethane elastomers, in particular of thermoplastic polyurethanes. These polyurethanes, in particular polyurethane elastomers, may be prepared via known reaction of conventional starting components, i.e. isocyanates, compounds reactive toward isocyanates, if appropriate blowing agents, preferably water, and, if appropriate, catalysts, and auxiliaries and/or additives, in the presence of the inventive carbodiimides. Here, it is preferable for the inventive carbodiimides to be added to the component which comprises the blowing agent, preferably water.

Preference is therefore given to processes for the preparation of polyurethanes, preferably of thermoplastic polyurethanes, preferably via reaction of isocyanates, compounds reactive toward isocyanates, if appropriate blowing agents, and, if appropriate, catalysts, and auxiliaries and/or additives, where the reaction is carried out in the presence of the inventive carbodiimides.

The carbodiimides are not only effective as stabilizer to inhibit hydrolytic degradation of polyaddition or polycondensation products containing ester groups, or for deacidification of polyesterols which can be used for the preparation of polyester-containing plastics, in particular of polyurethane rubbers, but are also suitable, by way of example, for the termination of esterification reactions during the preparation of polyesters, when the desired degree of polycondensation has been achieved.

The inventive thermoplastically processible polyurethane elastomers may be used for extrusion products, injection-molding products, or calendered products, and also for powder slush processes.

The inventive carbodiimides are preferably used in thermoplastic polyurethanes. The present invention therefore provides processes for the preparation of thermoplastic polyurethane and provides crosslinkable TPUs thus obtainable, in particular cable sheathing, fibers, or hoses, in particular compressed-air hoses, and also the corresponding crosslinked products. The invention also provides cable sheathing, fibers, or hoses, in particular compressed-air hoses, based on thermoplastic polyurethane which has been crosslinked by way of the inventive carbodiimides, in particular cable sheathing, fibers, or hoses in which the crosslinked thermoplastic polyurethane has a Shore A hardness of from 85 to 98 and a Vicat point to DIN EN ISO 306 (10N /120 K/h) above 130° C., particularly preferably above 140° C., in particular above 145° C.

Conventional processes, e.g. injection molding or extrusion, are used to process the TPUs prepared according to the invention, which are usually in the form of granules or powder, to give injection-molded and extruded products, e.g. the desired films, moldings, rollers, fibers, cladding in automobiles, hoses, cable plugs, bellows, drag cables, cable sheathing, gaskets, drive belts, or damping elements. These injection-molding and extrusion products may also be composed of compounded materials comprising the inventive TPU and at least one other thermoplastic, particularly a polyethylene, polypropylene, polyester, polyether, polystyrene, PVC, ABS, ASA, SAN, polyacrylonitrile, EVA, PBT, PET, polyoxymethylene. The TPU prepared according to the invention may in particular be used to produce the products described at the outset.

A preferred method uses the thermoplastic polyurethane comprising the inventive carbodiimides in well-known processes to spin fibers or to extrude hoses, in particular compressed-air hoses, followed by crosslinking of the thermoplastic polyurethane by way of the alkenyl groups, if appropriate using a catalyst which accelerates crosslinking. The crosslinking reactions by way of and via the double bonds of the carbodiimide are familiar to the person skilled in the art and are well known.

### EXAMPLES

### Example 1

### Preparation of Inventive Stabilizers: bis[1-(3-isopropenylphenyl)-1-methylethyl]-carbodiimide.

1000 parts by weight (4.97 mol) of 1-(3-isopropenylphenyl)-1-methylethyl isocyanate with an NCO content of 20.9% by weight were heated to 180° C. in the presence of 2.0 parts by weight of 1-methyl-2-phospholene 1-oxide, without solvent, and condensed at this temperature with moderate evolution of carbon dioxide. Once the NCO content of the reaction mixture had reached 5% by weight, the reaction time required for this being about 24 hours, the added catalyst and residues of unreacted 1-(3-isopropenylphenyl)-1-methylethyl isocyanate were removed by distillation at a temperature of 190° C., at a pressure of 0.2 mbar.

This gave about 327 parts by weight of bis[1-(3-isopropenylphenyl)-1-methylethyl]-carbodiimide with small amounts of unreacted 1-(3-isopropenylphenyl)-1-methylethyl isocyanate (isocyanate content <0.1% by weight). The structure was demonstrated via ¹H NMR and IR spectra. The content of —N═C═N groups was 12.2% by weight.

### Example 2

500 parts by weight (2.1 mol) of 1,3-bis(1-methyl-1-isocyanatoethyl)benzene with an NCO content of 34.4% by weight were heated to 180° C. with 450 parts by weight (2.2 mol) of 1-(3-isopropenylphenyl)-1-methylethyl isocyanate with an NCO content of 20.9% by weight in the presence of 2.0 parts by weight of 1-methyl-2-phospholene 1-oxide, without solvent, and condensed at this temperature with moderate evolution of carbon dioxide. Once the NCO content of the reaction mixture had reached 5% by weight, the reaction time required for this being about 24 hours, the added catalyst and residues of unreacted 1,3-bis(1-methyl-1-isocyanatoethyl)benzene and 1-(3-isopropenylphenyl)-1-methylethyl isocyanate were removed by distillation at a temperature of 190° C., at a pressure of 0.2 mbar.

This gave 530 parts by weight of a mixture composed of mono- and oligomeric polycarbodiimides with an NCO content of <0.1% by weight, and with 12% content of —N═C═N groups.

¹H NMR and IR spectra were used to demonstrate the structure of the mixture containing isocyanate groups and composed of mono- and oligomeric polycarbodiimides.

### Example 3

### Production of TPU Specimens

Polyol 1)

Polyester polyol (butanediol/hexanediol adipate, molecular weight 2000, OH number=56.1; BASF Aktiengesellschaft)

Polyol 2)

Polyester polyol (butanediol/ethylene glycol adipate, molecular weight 2000, OH number=56.1; BASF Aktiengesellschaft)

The polyols stated in table 1 were mixed at 80° C. with 1,4-butanediol. The various hydrolysis stabilizers listed in table 1 were then added, with stirring.

TABLE 1

| | Experiment | | | | | | | | |
|---|---|---|---|---|---|---|---|---|---|
| | 1 | | 2 | | 3 | | 4 | | 5 |
| Polyol 1 | 1000 | g | 1000 | g | 1000 | g | 1000 | g | 1000 g |
| Butanediol | 110 | g | 110 | g | 110 | g | 110 | g | 110 g |
| Elastostab | 8 | g | — | | — | | — | | — |
| H01 ® | | | | | | | | | |
| Stabaxol 1 ® | — | | 8 | g | — | | — | | — |
| Stabilizer 1 | — | | — | | 8 | g | — | | — |
| Stabilizer 2 | — | | — | | — | | 8 | g | — |
| | Experiment | | | | | | | | |
| | 6 | | 7 | | 8 | | 9 | | 10 |
| Polyol 2 | 1000 | g | 1000 | g | 1000 | g | 1000 | g | 1000 g |
| Butanediol | 110 | g | 110 | g | 110 | g | 110 | g | 110 g |

| | | | | | | |
|---|---|---|---|---|---|---|
| Elastostab | 8 | g | — | — | — | — |
| H01 ® | | | | | | |

| | | | | | | |
|---|---|---|---|---|---|---|
| Stabaxol 1 ® | — | 8 | g | — | — | — |

| | | | | | | |
|---|---|---|---|---|---|---|
| Stabilizer 1 | — | — | 8 | g | — | — |

| | | | | | | |
|---|---|---|---|---|---|---|
| Stabilizer 2 | — | — | — | 8 | g | — |

Elastostab® H01: polymeric carbodiimide (hydrolysis stabilizer) from Elastogran GmbH
Stabaxol® 1: monomeric carbodiimide (hydrolysis stabilizer) from Rheinchemie GmbH
Stabilizer 1: stabilizer prepared in example 1
Stabilizer 2: stabilizer prepared in example 2

The glycol mixture was controlled to 80° C., with stirring.

425 g of 4,4′-MDI (methylenediphenyl diisocyanate) were then added and stirring was continued until the reaction mixture was homogeneous. The mixture was then poured into a flat Teflon dish and annealed at 125° C. for 10 min on a hotplate. The resultant TPU skin was annealed at 100° C. for 24 h in a heated cabinet. The cast sheets were granulated and then processed in an injection-molding machine to give 2 mm injection-molded sheets. The mechanical properties were determined and are listed in table 2.

TABLE 2

| | | | | Tear | | |
|---|---|---|---|---|---|---|
| | | | | propa- | | |
| | Shore | | Tensile | gation | | |
| | hard- | Tensile | strain at | resis- | | |
| Stabilization | ness | strengh | break | tance | Abrasion | Density |
| method | [A] | [mPas] | [%] | [N/mm] | [mm³] | [g/cm³] |
| Experiment 1 | 82 | 49 | 580 | 65 | 35 | 1.183 |
| Experiment 2 | 82 | 52 | 600 | 68 | 34 | 1.183 |
| Experiment 3 | 85 | 48 | 520 | 64 | 36 | 1.183 |
| Experiment 4 | 84 | 47 | 540 | 66 | 35 | 1.184 |
| Experiment 5 | 84 | 44 | 630 | 75 | 33 | 1.185 |
| Experiment 6 | 84 | 47 | 700 | 67 | 36 | 1.218 |
| Experiment 7 | 85 | 50 | 700 | 73 | 41 | 1.218 |
| Experiment 8 | 84 | 47 | 670 | 70 | 40 | 1.219 |
| Experiment 9 | 83 | 45 | 690 | 71 | 39 | 1.217 |
| Experiment 10 | 85 | 47 | 620 | 70 | 38 | 1.225 |

TABLE 3

| Properites | Unit | DIN | ISO |
|---|---|---|---|
| Hardness | Shore A | 53505 | 868 |
| Density | kg/m³ | 53479 | 1183 |
| Tensile strength | MPa | 53504 | 37 |
| Tensile strain at break | % | 53504 | 37 |
| Tear propagation resistance | N/mm | 53515 | 34 |
| Abrasion | mm³ | 53516 | 4649 |

### Determination of Resistance to Hydrolysis

S2 test specimens were stamped out from the injection-molded sheets, and these were placed in glass containers (250 and 500 ml) with distilled water and placed in a temperature-controlled cabinet at a defined temperature (80° C.). At certain intervals (e.g. weekly) 3 test specimens were removed. The specimens were then aged in standard 23/50 conditions of temperature and humidity for not less than 30 minutes, and tensile strength and tensile strain at break were determined.

TABLE 4
Measurement of tensile strength [MPa] as
a function of time [days]

| Expired | Experi- | Experi- | Experi- | Experi- | Experi- |
|---|---|---|---|---|---|
| time | ment | ment | ment | ment | ment |
| [d] | 1 | 2 | 3 | 4 | 5 |
| 0 | 49 | 52 | 48 | 47 | 44 |
| 7 | 44 | 44 | 43 | 42 | 25 |
| 14 | 45 | 46 | 44 | 42 | 7 |
| 21 | 44 | 44 | 44 | 41 | Disinte- |
| | | | | | grated |
| 28 | 43 | 43 | 42 | 41 | |
| 35 | 42 | 40 | 43 | 40 | |
| 42 | 42 | 38 | 43 | 40 | |
| 49 | 42 | 40 | 43 | 39 | |
| 56 | 42 | 33 | 43 | 38 | |
| 63 | 40 | 17 | 43 | 39 | |
| 70 | 41 | 4.75 | 41 | 37 | |
| 77 | 36 | 2 | 41 | 37 | |
| 84 | 24 | Disinte- | 40 | 38 | |
| | | grated | | | |
| 91 | 6 | | 42 | 36 | |
| 98 | Disinte- | | 38 | 35 | |
| | grated | | | | |
| 105 | | | 40 | 30 | |
| 112 | | | no more test | | |
| | | | specimens | | |
| | | | available | | |

TABLE 5
Measurement of tensile strain at break [%] as
a function of time [days]

| Expired | Experi- | Experi- | Experi- | Experi- | Experi- |
|---|---|---|---|---|---|
| time | ment | ment | ment | ment | ment |
| [d] | 1 | 2 | 3 | 4 | 5 |
| 0 | 580 | 600 | 520 | 540 | 630 |
| 7 | 520 | 560 | 540 | 530 | 770 |
| 14 | 550 | 570 | 550 | 550 | 530 |
| 21 | 540 | 580 | — | #NV | Disinte- |
| | | | | | grated |
| 28 | 550 | 600 | 640 | 580 | |
| 35 | 540 | 580 | 620 | 610 | |
| 42 | 620 | 650 | 620 | 620 | |
| 49 | 590 | 650 | 630 | 620 | |
| 56 | 620 | 730 | 660 | 650 | |
| 63 | 590 | 780 | 640 | 630 | |
| 70 | 610 | 275 | 620 | 650 | |
| 77 | 610 | 40 | 610 | 630 | |
| 84 | 750 | Disinte- | 620 | 640 | |
| | | grated | | | |
| 91 | 450 | | 640 | 700 | |
| 98 | Disinte- | | 590 | 520 | |
| | grated | | | | |
| 105 | | | 680 | 310 | |
| 112 | | | no more test | | |
| | | | specimens | | |
| | | | available | | |

TABLE 6
Measurement of tensile strength [MPa] as
a function of time [days]

| Expired- | Experi- | Experi- | Experi- | Experi- | Experi- |
|---|---|---|---|---|---|
| time | ment | ment | ment | ment | ment |
| [d] | 6 | 7 | 8 | 9 | 10 |
| 0 | 47 | 50 | 47 | 45 | 47 |
| 7 | 42 | 41 | 40 | 39 | 27 |
| 14 | — | — | — | — | 6 |
| 21 | 39 | 36 | 38 | 36 | Disinte- |
| | | | | | grated |
| 28 | 35 | 32 | 37 | 35 | |
| 35 | 27 | 16 | 37 | 35 | |
| 42 | 7 | 4 | 25 | 24 | |
| 49 | Disinte- | Disinte- | — | — | |
| | grated | grated | | | |
| 56 | | | 25 | 3 | |
| 63 | | | 6 | Disinte- | |
| | | | | grated | |
| 70 | | | Disinte- | | |
| | | | grated | | |

TABLE 7
Measurement of tensile strength at break [%] as
a function of time [days]

| Expired- | Experi- | Experi- | Experi- | Experi- | Experi- |
|---|---|---|---|---|---|
| time | ment | ment | ment | ment | ment |
| [d] | 6 | 7 | 8 | 9 | 10 |
| 0 | 700 | 700 | 670 | 690 | 620 |
| 7 | 640 | 660 | 630 | 650 | 770 |
| 14 | — | — | — | — | 420 |
| 21 | 690 | 700 | 650 | 670 | Disinte- |
| | | | | | grated |
| 28 | 680 | 780 | 670 | 690 | |
| 35 | 840 | 900 | 720 | 730 | |
| 42 | 580 | 280 | 760 | 770 | |
| 49 | Disinte- | Disinte- | — | — | |
| | grated | grated | | | |
| 56 | | | 870 | 300 | |
| 63 | | | 480 | Disinte- | |
| | | | | grated | |
| 70 | | | Disinte- | | |
| | | | grated | | |

1. A polyurethane comprising carbodiimide which has at least one alkenyl unit, and has a content smaller than 5 ppm, based on the total weight of the carbodiimide, of compounds which catalyze the formation of carbodiimides.

2. The polyurethane according to claim 1, wherein the content of phospholenes, phospholene oxides, phospholidines, and/or phospholine oxides, as compounds which catalyze the formation of carbodiimides, is smaller than 5 ppm, based on the total weight of the carbodiimide.

3. The polyurethane according to claim 1, wherein the content of 1-methyl-2-phospholene 1-oxide, as a compound which catalyzes the formation of carbodiimides, is smaller than 5 ppm, based on the total weight of the carbodiimide.

4. The polyurethane according to claim 1 comprising carbodiimide which has at least one isopropenyl unit.

5. The polyurethane according to claim 1 comprising carbodiimide which has the following structure:

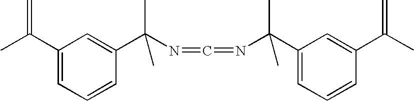

6. The polyurethane according to claim 1 comprising carbodiimide which has the following structure: 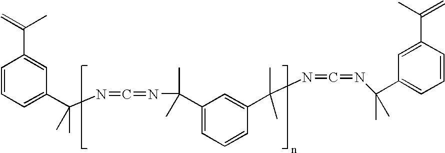
wherein n=1-20.

7. A process for the preparation of polyurethanes, which comprises carrying out the reaction in the presence of carbodiimides according to claim 1.
